(19) United States
(12) Patent Application Publication
(10) Pub. No.: US 2009/0029106 A1
(43) Pub. Date: Jan. 29, 2009

(54) PAPER PRODUCT AND METHOD OF PRODUCING A PAPER PRODUCT

(75) Inventors: Dirk Mauler, Ilvesheim (DE); Wolfram Schinkoreit, Unterabtsteinach (DE)

Correspondence Address: YOUNG & THOMPSON, 209 Madison Street, Suite 500, ALEXANDRIA, VA, 22314, US

(73) Assignee: SCA HYGIENE PRODUCTS GMBH, Mannheim (DE)

(21) Appl. No.: 12/067,462

(22) PCT Filed: Sep. 22, 2005
(86) PCT No.: PCT/EP05/10265

§ 371 Date: Jun. 1, 2008

(51) Int. Cl. B32B 3/30; B29C 59/02; D21H 25/04

(52) U.S. Cl. 428/141; 264/293; 162/109

(57) ABSTRACT

The invention relates to a paper product (1), in particular sanitary paper product, having at least one structured ply (10) of paper, the structured ply of paper comprising a background pattern (2, 3) having background protuberances. The background pattern comprises at least first zones (2) and second zones (3), the first zones having protuberances of a first protuberance density and the second zones having protuberances of a second protuberance density, the first protuberance density being lower than 30 protuberances/cm2 and the second protuberance density being different from the first protuberance density.

### FIELD OF THE INVENTION

The invention relates to a paper product, in particular for sanitary paper, having at least one structured ply of paper with the features according to the preamble of claim 1. Furthermore, the invention relates to a method of producing a paper product having at least one structured ply according to the preamble of claim 16. The technical field to which the invention pertains concerns paper for sanitary and domestic use, such as toilet paper, paper handkerchiefs, paper napkins, or paper towels. Such paper product comprises at least one structured ply of paper comprising a background pattern having background protuberances. Furthermore, multi-ply tissue paper for various uses as kitchen paper, toilet paper or handkerchiefs involve a plurality of plies of paper which are bonded together to form a multi-ply paper.

General goals with respect to paper products in this field are to provide a softness and improved feel, good mechanical strength and the desired absorption properties together with a unique appearance and sufficient bulk.

### DESCRIPTION OF THE PRIOR ART

In paper products, in particular sanitary paper products, plies can be structured by different methods. A first method for providing a structured ply of paper is the use of a TAD

(Through Air Drying) process which gives the paper a three-dimensional structure already in the paper machine.

A further method involves the embossing of tissue plies using a single nip or multi nip embossing. However, the embossing usually hardens the product and contributes to a rough feeling of the product. On the other hand, it is possible to use micro embossing with a high density of protuberances of more than 40 protuberances/cm². A micro embossed product feels soft. However, micro embossed paper feels as if it could not absorb enough liquid.

Therefore, there is a constant desire to provide a tissue product which balances a high softness surface, sufficient bulk and the desired fluid absorption properties.

U.S. Pat. No. 6,106,928 describes an embossed absorbent paper having combined patterns consisting of at least one ply of absorbent, creped paper of a specific surface weight between 12-35 g/m². The paper has first and second protrusions respectively arrayed in a graphic pattern and a background pattern. The graphic pattern is composed of pattern elements comparatively wide spaced apart from one another and each pattern element is constituted of at least one of the first protrusions. The background pattern comprises the second protrusions arrayed more tightly between the pattern elements. The pattern elements form the graphic pattern arrayed in a density of at most 0.5 elements/cm² and the second protrusions arrayed at a rate of at least 30/cm². This embossing structure leads to a suggestive and attractive graphic pattern and a thick paper with good absorbent qualities.

### SUMMARY OF THE INVENTION

It is the object of the invention to provide a paper product, in particular for sanitary paper, which combines in an advantageous way a high softness and the feeling of adequate liquid absorbance and which, at the same time, provides the necessary bulk.

This object is solved by a paper product with the features of claim 1. A method for producing such a paper product is characterized by the features of claim 16. According to this solution, a paper product, in particular for sanitary paper, has at least one structured ply of paper whereas the structured ply of paper comprises a background pattern having background protuberances. According to the invention, the background pattern comprises at least first zones and second zones, the first zones having protuberances of a first protuberance density and the second zones having protuberances of a second protuberance density, the first protuberance density being lower than 30 protuberances/cm² and the second protuberance density being different from the first protuberance density. Such background pattern provides a paper, which has, on the one hand, the soft feel of a protuberance pattern with a high protuberance density and on the other hand the appearance as if it could absorb a sufficient amount of liquid in the zones of a low protuberance density.

A background pattern is understood to mean a structural pattern that is distributed basically all over the plane of the ply and effects its overall appearance and feeling. This background pattern is contrasted to a design pattern that is applied to specific areas only and is clearly distinguishable over the background pattern.

The resulting paper product combines the advantages of high softness and high liquid absorbance properties. Furthermore, due to the at least two different background pattern zones, such paper product has a unique appearance. The inventive method of producing a paper product, in particular sanitary paper product, having at least one structured ply comprises, according to claim 16, the step of structuring the ply with a background pattern having first zones with first protuberances with a first protuberance density lower than 30 protuberances/cm² and having second zones with second protuberances with a second protuberance density different from that of the first protuberance density.

The method provides a paper product which combines advantageously the properties of a first zone having a lower protuberance density of 30 protuberances/cm² which appears to provide a sufficiently high liquid absorbance with the properties of a second zone having a different, preferably higher, dot density which contributes to a soft feel of the surface of the ply of the paper product.

Preferred embodiments of the invention are characterized by the dependent claims.

According to a preferred embodiment, the second protuberance density of the second zone is higher than the first protuberance density of the first zone. Preferably, the second protuberance density of the second zone is equal to, or higher than 30 protuberances/cm². The different protuberance densities of the first and second zones, where the first zone has a protuberance density lower than 30 protuberances/cm² and the second protuberance density of the second zone has a protuberance density of more than 30 protuberances/cm², lead to a paper product which can achieve the desired properties.

In a preferred embodiment, the combined average protuberance density of the background pattern is lower than 30 protuberances/cm². Such a paper product has an appearance that is very soft on the one hand due to the high protuberance density in the second zone but has the overall appearance that it has supreme liquid absorbing characteristics due to the low overall average density of the protuberances.

In a preferred embodiment the first and second zones are arranged in an alternating pattern on the surface of the structured ply. When using such alternating pattern, the characteristics of the two zones merge together and provide a paper with the haptic properties desired. Furthermore, such background pattern is especially appealing to the eye.

Preferably, the first zones and the second zones have geometrical shapes such that they basically cover the ply entirely. In order to achieve this, the second zones may have geometrical shapes which are inverted with regard to the shapes of the first zones. In other words, in an preferred embodiment the shapes of the first zones and second zones are such that they can be placed next to each other almost seamlessly.

In preferred embodiments of the invention, the first zones and second zones can have geometrical shapes, in particular of triangles, rectangles circles, ellipses or waved bands in diagonal, longitudinal or cross direction of the paper product. With these different geometrical shapes it is possible, on the one hand, to cover the surface of the ply almost entirely and, on the other hand, to provide a unique appearance of the such structured background pattern.

In a preferred embodiment the first protuberances of the first zone and the second protuberances of the second zone extend in different directions with regard to the plane defined by the structured ply. Such ply provides an surface on the one side of the ply that appears to have an improved absorption property and an surface on the other side of the ply with an increased softness.

To further improve the appearance and properties of the paper product in an preferred embodiment, the structured ply of paper has, furthermore, a design pattern comprising design protrusions. Such design protrusions can be in the form of geometrical shapes, such as flowers, feathers, or even trademark symbols of the manufacturer or the retailer. It is preferred to arrange the design protrusions, the first protuberances of the first zones and the second protuberances of the second zones to form a repeating pattern in order to efficiently produce the paper product and to improve the appearance of the paper product.

To improve the appearance of the paper product further, the design protrusions density can be lower than the average background protuberance density. In other Words, the design protrusions are spaced apart from each other wider than the background protrusions.

To form an even more comfortable paper product, the paper product comprises at least two plies, at least one of which is structured by the background pattern. In preferred embodiments, the background protuberances and/or the design protrusions are embossed in the ply.

In another embodiment, the background protuberances and/or the design protrusions are formed by TAD process, in particular in the paper machine. For all above-described embodiments, the background pattern comprises at least a first and a second zone whereas the first zones has protuberances of a first protuberance density and the second zones has protuberances of a second protuberance density, whereas the first protuberance density is lower than 30 protuberances/cm² and the second protuberance density is different from the first protuberance density.

The background pattern may also comprise in addition to the first zones and the second zones, third, fourth, fifth or even more zones of different protuberance density, whereby such zones may also be unembossed zones being characterized by a density of 0 protuberances/cm². Preferably the combined average protuberance density of the background pattern of such zones is lower than 30 protuberances/cm².

The term “protuberances” according to the invention comprises all kinds of different protuberances of any geometrical shape including male as well as female protuberances. Preferably the height of such protuberances ranges between 0.1 and 2 mm, especially between 0.1 and 1.5 mm and most preferably between 0.2 and 1 mm.

Such protuberances may have an equal height or they may differ in height. It is also within the scope of the invention that each zone is characterized by protuberances of equal height as well as of different height. In an additional embodiment of the invention, each zone has protuberances of a constant height, however such zone differs from the other zone(s) in view of the height of the protuberances.

### BRIEF DESCRIPTION OF THE DRAWINGS

In the following, the invention is described by way of example only, with reference to the accompanying drawing in which:

FIG. 1 is a schematic plan view on a structured ply of a paper product according to the invention.

### DETAILED DESCRIPTION OF THE PREFERRED EMBODIMENT

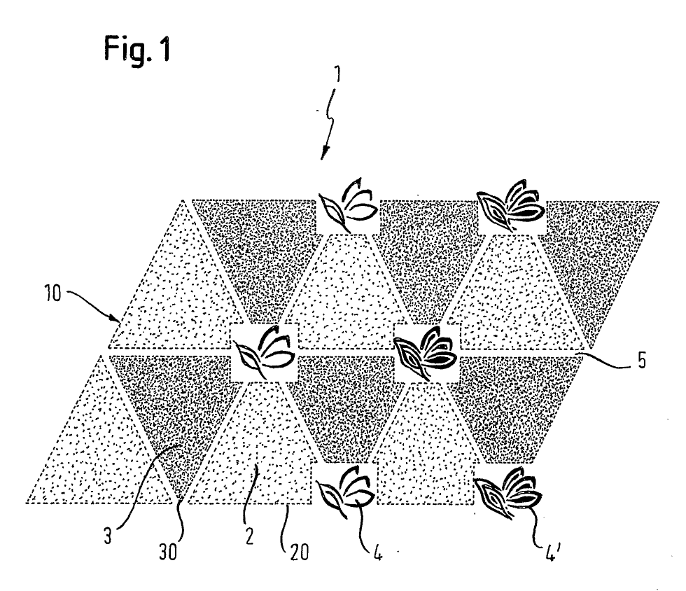

FIG. 1 shows a paper product 1 having at least one structured ply 10. The structured ply 10 is structured by a background pattern comprising first zones 2 and second zones 3. The first zones 2 have protuberances with a first protuberance density lower than 30 protuberances/cm². The second zones 3 have a protuberance density that is different from the first protuberance density and, in this embodiment, higher than that of the first protuberance density. In particular, in this embodiment the first protuberance density of the first zones 2 is 15 dots/cm² whereas the protuberance density of the second zones 3 is 40 dots/cm².

Since the first zones and the second zones in this embodiment cover the same surface area, this results in an overall combined average protuberance density of the background pattern of 27.5 dots/cm².

It should be noted, however, that, in order to achieve a combined average protuberance density of the background pattern lower than 30 protuberances/cm², it is conceivable to use protuberance densities different from that indicated above.

Furthermore, in order to achieve a combined average protuberance density of the background pattern lower than 30 protuberances/cm², the surface area of the first zones and the surface area of the second zones can be made different from each other. In particular, the surface area of the first zones 2 can be twice as large as that of the second zones 3. In the current example, with the same dot densities assumed, this would lead to an overall dot density of the background pattern of 23.3 dots/cm².

In the embodiment of FIG. 1, the first zones 2 as well as the second zones 3 are shaped in the form of triangles. However, the shape of the first zone triangle 2 is inverted with respect to the second zone triangle 3 in the sense that the first zone triangle 2 points with its base side 20 to the lower end of the FIG. 1 whereas the second zone triangle 3 points in this direction with its tip end 30. This results in a geometrical structure where one first zone 2 and one second zone 3 triangles combined together result in a parallelogram shape. Furthermore, the shapes of the first zones 2 and the second zone 3 allow that the whole surface area of the structured ply 10 can be covered with the background pattern of the two zones.

It is, however, conceivable to use other geometrical shapes for covering the top surface of the structured ply.

Furthermore, it is apparent that not necessarily the complete surface area of the structured ply is covered with a structuring pattern in the sense that every part of the surface area is structured.

As can be seen from FIG. 1, unstructured areas 5 are situated between the first zones 2 and the second zones 3. It is conceivable, however, that these unstructured areas 5 are not present in an alternative of the embodiment of FIG. 1.

In another alternative it is conceivable, however, to even increase the unstructured areas between the first zones and second zones compared to the arrangement shown in FIG. 1.

In addition to the background pattern comprising the first zones 2 and second zones 3, a design pattern with design elements 4, 4′ is additionally provided in the paper product of FIG. 1. The design pattern comprises design protrusions 4, 4′, which represent the design pattern. The protrusions 4, 4′ may have the shape of flowers, as shown in FIG. 1, or feathers or leaves or any other geometrical figures or symbols that are suitable for the paper product. A design pattern can consist of one single protrusion or a plurality of protrusions arranged together to form a complex design.

Further, the design protrusions advantageously project above the embossed background protrusions.

The design pattern is, in the shown embodiment, situated in the crossings between the first zones 2 and second zones 3. The design pattern could, however, be arranged in an alternative of the embodiment shown in FIG. 1 such that the design protrusions 4, 4′ are arranged centrally within either the first zones 2 or the second zones 3.

Any similarity to the flower pattern in the drawing with Georgia Pacific France's French registered design No. 94 0171 and international industrial design No. DM/030134, and with Georgia Pacific Sarl's Benelux trademark registration No. 633 105, Irish trademark registration No. 211, 145, Greek trademark registration No. 139 275 and international trademark registration No. 708 750 is purely coincidental.

1-25. (canceled)

26. Paper product having at least one structured ply of paper, the structured ply of paper comprising a background pattern having background protuberances, wherein the background pattern comprises at least first zones and second zones, the first zones having protuberances of a first protuberance density, and the second zones having protuberances of a second protuberance density, the first protuberance density being lower than 30 protuberances/cm², and the second protuberance density being different from the first protuberance density.

27. The paper product according to claim 26, wherein the second protuberance density is higher than the first protuberance density.

28. The paper product according to claim 27, wherein the second protuberance density is equal to or higher than 30 protuberance/cm².

29. The paper product according to claim 26, wherein the combined average protuberance density of the background pattern is lower than 30 protuberances/cm².

30. The paper product according to claim 26, wherein the first and second zones are arranged in an alternating pattern.

31. The paper product according to claim 26, wherein the structured ply defines a plane, and the first protuberances of the first zone and the second protuberances of the second zone extend in different directions with regard to the plane defined by the structured ply.

32. The paper product according to claim 26, wherein the first zones and the second zones have geometrical shapes such that they basically cover the ply entirely.

33. The paper product according to claim 32, wherein the second zones have a geometrical shape which is inverted with regard to the shape of the first zones.

34. The paper product according to claim 26, wherein the first zones and second zones have geometrical shapes selected from the group consisting of triangles, rectangles, circles, ellipses and waved bands in diagonal, longitudinal or cross direction of the paper product.

35. The paper product according to claim 26, wherein the structured ply of paper comprises a design pattern comprising design protrusions.

36. The paper product according to claim 35, wherein the design protrusions, the first protuberances of the first zones and the second protuberances of the second zones are arranged to form a repeating pattern.

37. The paper product according to claim 35, wherein the design protrusions density is lower than the average background protuberance density.

38. The paper product according to claim 35, wherein at least one of the background protuberances and the design protrusions are embossed in the ply.

39. The paper product according to claim 26, comprising at least two plies, at least one of which is structured by the background pattern.

40. The paper product according to claim 26, wherein the background pattern comprises in addition to first zones and second zones at least additional third zones.

41. Method of producing a paper product having at least one structured ply comprising the step of: structuring the ply with a background pattern having first zones with first protuberances with a first protuberance density lower than 30 protuberances/cm², and having second zones with second protuberances with a second protuberance density different from that of the first protuberance density.

42. Method of producing a paper product according to claim 41, wherein the second protuberance density is higher than the first protuberance density.

43. Method of producing a paper product according to claim 41, further comprising the additional step of structuring the ply with a design pattern having design protrusions.

44. The method of producing a paper product according claim 41, wherein the second protuberance density is higher than 30 protuberances/cm².

45. The method of producing a paper product according claim 41, wherein the combined average protuberance density of the protrusions of the background pattern is lower than 30 protuberances/cm².

46. The method of producing a paper product according to claim 41, wherein the first and second zones are arranged in an alternating pattern.

47. The method of producing a paper product according to claim 41, wherein the design protrusions, the first protuberances of the first zones and the second protuberances of the second zones are formed in a repeating pattern.

48. The method of producing a paper product according to claim 43, wherein at least one of the background protuberances and the design protrusions are formed by embossing the ply.

49. The method of producing a paper product according to claim 43, wherein structuring of the background protuberances and/or the design protrusion is performed by a TAD process.

50. The method of producing a paper product according to claim 41, wherein at least a second ply is combined with the structured ply to form the paper product.
